(19) United States
(12) Patent Application Publication
(10) Pub. No.: US 2006/0216401 A1
(43) Pub. Date: Sep. 28, 2006

(54) Process for producing a carbohydrate composition

(76) Inventors: Derek Robin Haisman, FIELDING (NZ); Richard Hamilton Archer, Palmerston North (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/536,887

(22) PCT Filed: Dec. 10, 2003
(86) PCT No.: PCT/NZ03/00270

§ 371 Date: Apr. 7, 2006

(30) Foreign Application Priority Data
Dec. 10, 2002 (NZ) 523100

(51) Int. Cl. A23G 3/00

(52) U.S. Cl. 426/658

(57) ABSTRACT

The present invention concerns a process for the production of a carbohydrate composition from lactose comprising a mixture of 10-50% galactose, 048% glucose, 1-25% fructose, 148% gluconic acid and 0-25% unconverted lactose and non-lactose di- and oligo-saccharides; and compositions produced by the process as well as food and drink containing the compositions.

### FIELD OF THE INVENTION

The present invention relates to a process for the production of a carbohydrate composition comprising a mixture of sugars specifically, although by no means exclusively as a syrup, from a starting material of lactose. The present invention also relates to the compositions produced by the process of the invention as well as the foods and drinks containing the compositions.

### BACKGROUND

Carbohydrate compositions comprising a mixture of sugars, such as lactose, glucose, galactose, fructose etc. are useful as food and drink additives in commercial food and drink production. For example, compositions comprising approximately 40-50% galactose, 25-30% fructose and 25-30% glucose are useful in the manufacture of sports drinks and energy snacks for sportsmen, confectionery, or for people having special food requirements such as diabetics (EP 0499165).

Known processes for producing such a composition include simple admixing of individual purified sugars in the required amount. However, sugars in their pure form may be quite expensive, and the purity and therefore quality for each sugar may vary from source to source, resulting in variability of the end composition.

Other known processes include one or more enzyme conversions of one sugar to another thereby producing a mixture of at least two sugars. Additional sugars may then be added from a purified source to complete the desired composition.

For example U.S. Pat. No. 3,852,496 describes a method of producing a sweetening composition from whey containing lactose using immobilized beta-galactosidase (lactase) and glucose isomerase. The lactose is passed over a flow-through column containing immobilized lactase to produce glucose, galactose and unhydrolysed lactose. This composition is either used directly or treated with glucose isomerase to produce a composition containing fructose, glucose, galactose and lactose.

Poutanen et al. (1978) describe the conversion of glucose to fructose in hydrolysed whey and lactose syrups by glucose isomerase treatment using immobilized enzyme technology. To increase efficiency of the process, a purified source of glucose was added to the hydrolysed lactose syrup before isomerisation to increase the relative content of fructose and therefore to increase the sweetness of the resulting composition.

Chiu and Koskowaski (1985) describe the hydrolysis of whey lactose followed by glucose isomerisation with added glucose and subsequent purification of fructose syrup.

Harju and Kruela (1980) describe the hydrolysis of whey lactose to produce a mixture of sugars which increases in sweetness to a maximum when hydrolysis is 80% complete. Further hydrolysis above this level does not increase the sweetness but does significantly increase the cost of hydrolysis. To increase sweetness further, glucose is isomerised to fructose.

The above prior art methods are mainly concerned with obtaining carbohydrate compositions having maximum sweetness. Galactose is a carbohydrate which is not particularly sweet and not, therefore, a desirable component of those prior art compositions.

Galactose is a particularly desirable ingredient of compositions which are useful in sports drinks etc. (U.S. Pat. No. 5,780,094) as it is easily and quickly absorbed to provide a rapid energy source as well as aiding in replenishment of glycogen reserves in the liver. Unfortunately, at present, it is not possible to simply add pure galactose to the prior art compositions as sources of galactose are not available in sufficient commercial quantities for large scale consumer products. In addition, even if sufficient quantities were available, such galactose would be prohibitively expensive and could not compete with conventional cheaper energy sources used in commercial sports drinks such as sucrose. This is because it is difficult to separate galactose from other sugars with which it occurs naturally, such as glucose, arabinose, mannose, fructose etc. The most common sources of galactose are from milk or from pectin where it occurs as a side chain, and requires a complex separation process. It was also a common problem with separation processes that a loss of yield of valuable intermediates and end product occurs, thus making such separation processes not commercially viable.

It is an object of the present invention to provide a process for producing a composition comprising a mixture of sugars including galactose and/or to provide a cheap and convenient method of producing purified galactose which overcomes, at least to some extent, the problems aforesaid and/or provides the public with a useful choice.

### SUMMARY OF THE INVENTION

The present invention provides a process for the production of a composition comprising a mixture of approximately 10-50% galactose, 0-48% glucose, 1-25% fructose, 1-48% gluconic acid and 0-25% “others” comprising unconverted lactose and non-lactose di- and oligo-saccharides as a % of the total carbohydrate present. Preferably the composition comprises 30-50% galactose, 10-40% glucose, 5-25% fructose, 1-15% gluconic acid and 1-10% “others”. Most preferably, the composition comprises 45-50% galactose, 23-33% glucose, 15-23% fructose, 1-5% gluconic acid and less than 7% “others”.

In a first embodiment, the invention provides a process comprising the steps:
(i) hydrolysis of lactose to produce glucose and galactose;
(ii) partial isomerisation of the glucose to fructose; and
(iii) partial oxidation of the glucose to gluconic acid;
   to produce a composition comprising a mixture of galactose, glucose, fructose, gluconic acid, unconverted lactose and non-lactose di- and oligo-saccharides without the need for any purification steps.

The process may be carried out as a continuous, semi-continuous, batch, sequence batch or single-pot process.

The isomerisation step (ii) may be carried out either before or after the oxidation step (iii).

The hydrolysis step (i) and oxidation step (iii) may be carried out simultaneously.

Alternatively, the product of step (i) may be separated into three streams and the first stream not treated further and the second and third streams treated according to steps (ii) or (iii) respectively and the products of each stream combined to provide a final composition according to the invention.

In a second embodiment, the invention provides a composition produced by the process, wherein said composition comprises a mixture of galactose, glucose, fructose, gluconic acid and unconverted lactose and non-lactose di- and oligo-saccharides. The undiluted composition is generally in the form of a syrup of 40 to 80° Brix but this may be diluted to any desired strength.

The composition comprises approximately 10-50% galactose, 0-48% glucose, 1-25% fructose, 1-48% gluconic acid and 0-25% “others” comprising unconverted lactose and non-lactose di- and oligo-saccharides. Preferably the composition comprises 30-50% galactose, 10-40% glucose, 5-25% fructose, 1-15% gluconic acid and 1-10% “others”. Most preferably, the composition comprises 45-50% galactose, 23-33% glucose, 15-23% fructose, 1-5% gluconic acid and less than 7% “others”.

In a third embodiment, the invention provides a food or drink containing the composition of the invention, and particularly a sports energy bar or sports drink, wherein said sports drink contains less than 25 mmol/litre of sodium.

In a fourth embodiment, the present invention provides a process for the production of galactose comprising the steps:
(i) hydrolysis of lactose to produce glucose and galactose;
(ii) partial isomeristion of the glucose to fructose;
(iii) partial oxidation of the glucose to gluconic acid;
(iv) crystallization of galactose to produce a mother liquor; and
(v) recovery of galactose crystals from the mother liquor.

In a fifth embodiment, the present invention provides galactose produced by the process of the invention.

In a sixth embodiment, the present invention provides a composition comprising the mother liquor produced by the process of the invention and its use as a sweetener in the food industry, and in particular, in the dairy food industry.

### BRIEF DESCRIPTION OF THE DRAWING

The invention will now be described by reference to the figure of the accompanying drawing in which:

FIG. 1 shows a schematic diagram of the process of the present invention.

### DETAILED DESCRIPTION

The present invention is concerned with a process for the production of a composition comprising a mixture of galactose, glucose, fructose, gluconic acid and unconverted lactose and non-lactose di- and oligo-saccharides, from lactose as a starting material. Such compositions are particularly usefull in the preparation of sports drinks and sports bars as a source of readily absorbable energy before, during or after exercise. Galactose is especially useful in this regard and the present invention is also concerned with a process for the production of galactose.

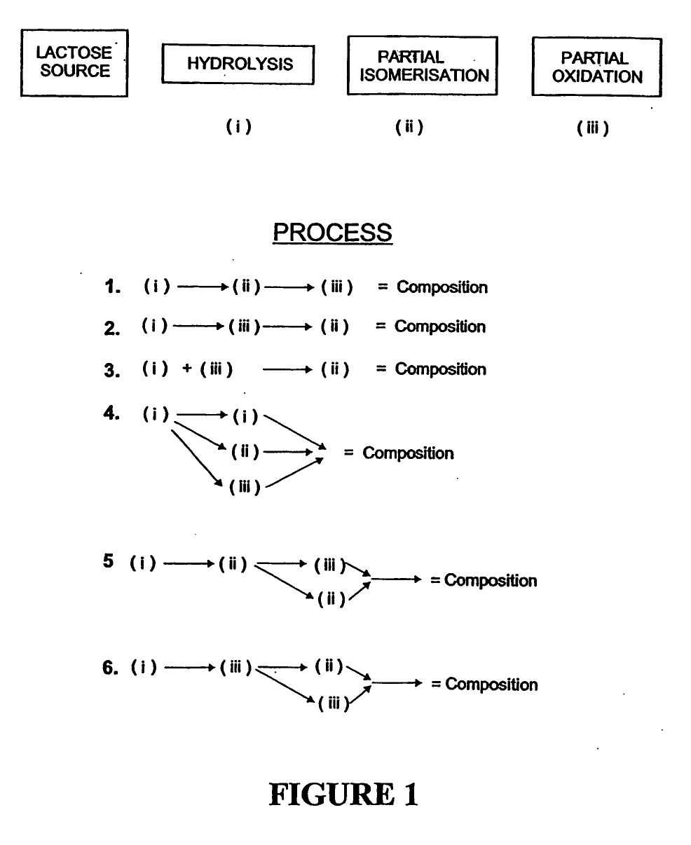

In a first embodiment the present invention provides a process comprising the steps:
(i) hydrolysis of lactose to produce glucose and galactose;
(ii) partial isomeristion of the glucose to fructose; and
(iii) partial oxidation of the glucose to gluconic acid;
   to produce a composition comprising a mixture of galactose, glucose, fructose, gluconic acid, unconverted lactose and non-lactose di- and oligo-saccharides without the need for any purification steps. This process is shown schematically in FIG. 1.

The process may be carried out as a continuous, semi-continuous, batch, sequenced batch or single-pot process.

The isomerisation step (ii) may be carried out either before or after the oxidation step (iii).

The hydrolysis step (i) and oxidation step (iii) may be carried out simultaneously.

Alternatively, the product of step (i) may be separated into three streams and the first stream not treated further and the second and third streams treated according to steps (ii) or (iii) respectively and the products of each stream combined to provide a final composition according to the invention.

Alternatively, the product of the partial isomerisation step (ii) may be split and a portion subjected to partial oxidation (step (iii)) and the remainder combined with the product of the partial oxidation step to produce a composition of the invention.

Alternatively, the product of the partial oxidation step (iii) may be split and a portion subjected to partial isomerisation (step (ii)) and the remainder combined with the product of the partial isomerisation step to produce a composition of the invention.

Preferably, the process comprises hydrolysis step (i) followed by partial oxidation step (iii) wherein the majority of this stream (e.g. 85%) is further processed via partial isomerisation step (ii) and the remaining portion of this stream (by pass) is combined with the product of the step (ii) to produce a composition of the invention having a desired fructose content.

The lactose source may be selected from the group comprising milk; UF permeate derived from whole milk, skim milk, whey or milk serum; pure lactose; whey; deproteinated whey; demineralised whey; decalcified whey; UF permeate derived from deproteinised, demineralised or decalcified whey; or any combination thereof.

The hydrolysis step (i) may be achieved chemically, including the use of acids, strong cation exchange resins, or enzymatically using one or more hydrolytic enzymes, or in a bioreactor.

The acids may comprise a weak solution (0.001-0.1% of total weight of lactose) of one or more acids selected from strong mineral acids such as hydrochloric acid, suphuric acid, phosphoric acid or nitric acid, and/or organic acids such as citric acid.

The hydrolytic enzyme (beta-galactosidase, also known as lactase) may be free or immobilized and may be sourced from Kluyveromyces lactis, Kluyveromyces fragilis, Kluyveromyces marxianus, Saccharomyces fragilis, Streptococcus thermophilus, Aspergillus oryzae, Aspergillus niger, Lactobacillus bulgaricus, Lactobacillus helviticus, Lactobacillus salivarius, Lactobacillus fermentum, Lactobacillus casei, Lactobacillus acidophilus, Steptococcus lactis, Bifidobacterium bifidum, Bifidobacterium longum, Bifidobacterium adolescentis, Bifidobacterium breve, Bacillus subtilis, Escherichia coli, Sulfolobus species, especially Sulfolobus solfataricus, Pyrococcus fusiosus, green coffee beans, jack beans, bovine liver, and bovine testes and any other suitable source either alone or in combination.

The hydrolysis reaction mixture is maintained under suitable conditions according to the source of the enzyme, its activity, temperature and pH optima and the amount of starting material as understood by a skilled person and as set out in the manufacturers' instructions. For Kluyveromyces-derived enzyme, the reaction mixture is maintained at pH 6.8-7.5 preferably 7.1-7.3, most preferably 7.2 using acid or alkali as required (e.g. NaOH, KOH, HCl, KH₂PO₄, K₂HPO₄, potassium or sodium citrate, magnesium carbonate, sulphuric acid, citric acid or a mixture thereof) and at 40-50° C. for approximately 8 hours. For Aspergillus-derived enzyme the reaction mixture is maintained at pH 3.5-7.5, preferably 4.5-7.0 and at 40-60° C.

The isomerisation step (ii) may be achieved chemically or enzymatically. When an enzyme is used, such a glucose isomerase enzyme may be free or immobilized and may be sourced from Actinoplanes missiourensis, Bacillus coagulans, Streptomyces murinus, Escherichia coli and Arthrobacter species. Again the reaction conditions are dependant on the source of the enzyme and manufacturers' recommendations may be followed. Generally, preferred conditions are similar to those used in the industrial production of high fructose corn syrup where starch derived dextrose is converted to a fructose/dextrose mixture. For the present invention, general conditions are 55-62° C. and 0.5-5 bed volumes/hour.

This step may be carried out in a membrane bioreactor. Preferably, this step carried out using an immobilized enzyme in a column format.

It is often desirable for sports drinks and sports foods generally to have a relatively low glycemic index and the presence of sugars other than glucose, or sugars which may be converted to glucose in the small intestine, is therefore important when formulating such drinks and foods. Galactose, for example, acts to reduce the glycemic index in a sports drink or food bar. It is a key feature of the present invention that it provides further reduction of the glycemic index through the oxidation step (iii) of highly glycemic glucose to gluconic acid. This is achieved concurrently with providing a food acid which is necessary to modify the taste and keeping quality of such foods and beverages.

The oxidation step (iii) may be achieved chemically or enzymatically. The enzyme conversion process requires two enzymes, a glucose oxidase and a catalase. The enzymes may be purchased as a mixed activity product or as separate products. Both enzymes may be added separately to the reaction mixture or added together as a mixed product or activities in a mixed product may be supplemented by adding one or both separate products. Such enzymes may be free or immobilized. The oxidase enzyme may be sourced from Penicillium notatum, Penicillium glaucanum, Penicillium amagosakiense and Aspergillus niger. The catalase enzyme may be sourced from Aspergillus niger, Penicillium species (as for oxidase, above) and Micrococcus lysodeikticus. The reaction conditions are dependent upon the source of the enzyme, its activity, amount of reactant etc. and the manufacturers' instructions may be followed. Generally, the reactions take place at 45-60° C., preferably 55-58° C. for 24 hours whilst in contact with air/oxygen. The pH of the reaction mixture is maintained around 4.5-6.5, preferably 5.6 by adding base. Alternatively, the oxidation step (iii) may be carried out in a membrane bioreactor. This step may also be carried out under hyperbaric pressure conditions as described in U.S. Pat. No. 4,345,031.

The oxidation step converts some of the glucose present in the reaction mixture to gluconic acid. Gluconic acid is considered to be a particularly desirable component of the composition of the present invention for several reasons. Firstly, by reducing the amount of glucose present in the composition, as discussed above, the glycemic index of the composition is reduced. Secondly, the acidity of the gluconic acid is desirable for sports drinks' applications and thirdly, the gluconic acid present acts to improve the flavour of the composition and subsequently diluted sports drinks as it assists in disguising the sodium flavour.

The hydrolysis step (i) and oxidation step (iii) may be carried out simultaneously where conditions allow, for example, where the agent used to control pH is compatible with hydrolysis, as would be appreciated by a skilled worker.

The process of the present invention may also include a number of optional filtration, ion exchange and carbon purification steps to purify the syrup produced by the process as would be appreciated by a skilled person. The process may also include pH adjustments to be made periodically to improve the overall efficiency of the process.

The composition produced by this process comprises approximately 10-50% galactose, 0-48% glucose, 1-25% fructose, 1-48% gluconic acid and 0-25% “others” comprising unconverted lactose and non-lactose di- and oligo-saccharides as a % of the final carbohydrate present. Preferably the composition comprises 30-50% galactose, 10-40% glucose, 5-25% fructose, 1-15% gluconic acid and 1-10% “others”. Most preferably, the composition comprises 45-50% galactose, 23-33% glucose, 15-23% fructose, 1-5% gluconic acid and less than 7% “others”.

The non-lactose di- and oligo-saccharides, together with the unconverted lactose (“others”) make up approximately 5% of the total carbohydrate content of the composition. This “other” component comprises bifidogenic material and may have a beneficial health effect in the sports drinks, sports bars and other food and drinks to which the composition is added. In addition, this ‘other’ component may provide some calorific value. Without being bound by theory, although it is not expected that these di- and oligo-saccharides will be adsorbed in the upper gastrointestinal tract, it is likely that they will be converted to short chain fatty acids and may be adsorbed in the colon to provide an energy source. It is also an advantage in the concentrated syrup of the invention in that this “other” component, particularly the non-lactose di- and oligo-saccharide component, acts to maintain all of the sugars in solution or inhibit crystallization to some degree.

The composition produced by the process of the present invention is generally in the form of a syrup of approximately 5° Brix. This composition may be used directly in a sports drink without further dilution. However, preferably the composition produced by the process of the invention is in the form of a concentrated syrup of 40-80° Brix, more preferably 70-75° Brix. The composition is concentrated by one or more evaporation steps. In particular, when step (i) is carried out alone or is combined with step (iii), the process may be carried out under dilute conditions, i.e. >75%-95% water (or a total solids content of 5-25%) and a thermal evaporation step carried out before step (ii) to increase the total solids to 40-60%. The syrup may be further dried in an evaporator, for example, if desired.

Preferably, the composition is in the form of a concentrated syrup and may be used as an additive in sports drinks and sports bars. In general 2.5-7.5% of the syrup solids is added to water and other ingredients such as flavours, to produce a sports drink. A major advantage of the process of the present invention is the flexibility of the process steps which may be varied to produce a final syrup of any desired composition. However, the sports drink made using the compositions of the present invention will always have a sodium content of less than 25 mmol/litre and are therefore distinguished from the sports drink described in U.S. Pat. No. 5,780,094.

One problem associated with the syrup of the invention is that it is prone to crystallization of the galactose component at temperatures between the range −10° C. to +30° C. depending on the concentration of the syrup. Therefore, to avoid crystallization, the syrup must be kept at a temperature outside of this range. This is not a problem once the concentrated syrup has been diluted into a sports drink. As mentioned above, the presence of the galactooligosaccharides in the ‘other’ component of the composition is thought to act to inhibit crystallization, but crystallization of galactose in particular, may still occur outside the abovementioned temperature range.

However, as discussed above, a pure source of galactose is not readily available as a large volume item of commerce, and a further embodiment of the present invention provides a process for the production of galactose comprising the steps
(i) hydrolysis of lactose to produce glucose and galactose;
(ii) partial isomeristion of the glucose to fructose;
(iii) partial oxidation of the glucose to gluconic acid;
(iv) crystallization of galactose by evaporation and/or cooling to produce a mother liquor; and
(v) recovery of galactose crystals from the mother liquor.

Steps (i), (ii) and (iii) of this process are the same as described above and may be carried out in the order and manner described above. Step (iv) may be carried out by cooling the syrup of the invention to a temperature between the range −10° C. to +30° C., preferably 4° C. to 20° C., whereby crystallization of pure galactose commences. Galactose crystallizes out of solution more efficiently at lower temperatures. Preferred conditions are 4° C. for up to 48 hours. The crystals may then be recovered in step (v) by centrifugation or filtration and washing with ice cold water the galactose may be air dried using a fluid bed dryer. This process is effective at crystallizing approximately 50% of the galactose present in the syrup composition of the invention. For example, if the syrup contains 48% of the carbohydrate as galactose, approximately 24-32% of this will crystallize as galactose. This process may be used for small or large scale manufacture of galactose.

The efficiency of crystallization is affected by the concentration of the syrup and temperature, as described above, and also by the complexity of the sugars present. The more complex carbohydrate present in the syrup, the more crystallization is inhibited. In particular, the more “others” component present, the more crystallization is inhibited. The higher the concentration of syrup, the more likely crystallization is to occur. For example, it is possible for a highly concentrated syrup (e.g. 80° Brix) to crystallize at temperatures between −10° C.-70° C. Such highly concentrated syrups must be kept at a temperature outside this range to avoid crystallization as would be understood by a skilled worker.

The supernatant liquid (or mother liquor) comprises 20% fructose, 40% glucose, 5% gluconic acid, 30% galactose and 5% others by weight of total carbohydrate and is sweeter than the composition produced by steps (i), (ii) and (iii) as galactose which has been removed, is less sweet than the remaining mixture of carbohydrates.

Thus the “mother liquor” composition is useful as a sweetener in the food industry and in particular, as it is produced from a dairy source, i.e. lactose, as a sweetener of dairy foods such as yogurt, mousse, ice cream, cream, sweetened milk drinks, etc.

The “mother liquor” is more stable than the syrup produced by the process of the first embodiment as it contains less galactose and is enriched with the “other” component and is therefore less prone to crystallization.

The “mother liquor” may be subjected to process steps (i), (ii) and/or (iii) or any combinations thereof to further modify its composition as would be understood by a skilled worker.

The purified galactose produced by the process of the invention may be added to the composition of the invention to increase the galactose content which would provide a superior syrup for use in sports drinks or sports bars. In particular, pure galactose may be added to the compositions of the invention to increase the galactose content to a desired level.

The invention will now be exemplified.

### EXAMPLES

### Example 1

Lactose monohydrate (BDH, 45 g) was dissolved in 255 g tap water. The pH of the solution was adjusted to pH 5 with citric acid. The flask was heated to 50° C. in a waterbath, and lactase (0.90 g of Enzidase Fungal Lactase 50,000 available from Zymus International, New Zealand) was stirred in. Hydrolysis was allowed to proceed at 50° C. for 24 hours. The solution was then cooled, and analysed for glucose. The glucose concentration was 7.1%.

The solution was then divided into 2 portions, A, 200 g and B, 100 g. Calcium carbonate (1.94 g) and glucose oxidase (Fermizyme 1500, 0.1 g) and catalase (Catazyme 25L, 0.1 g) were added to portion B in a flask and the flask vigorously shaken by a mechanical shaker in a water bath at 50° C. for 4 hours.

Portion A was placed in a flask and heated to 60° C. Glucose isomerase (Sweetzyme IT, 2 g) was added and kept in suspension by gentle shaking in a shaking incubator at 60° C. After 2 hours the Sweetzyme was allowed to sediment, and the supernatant solution was decanted from the settled enzyme through a filter paper (Whatman 541).

Both portions, A and B, were analysed for lactose, galactose and glucose, and then the solutions were mixed. The composition (w/w) of the product was 4.56% glucose, 7.01% galactose, 1.37% fructose, 0.42% oligo/di-saccharides and 1.1% gluconic acid and 14.5° Brix. This corresponded to a sugar composition, on a dry weight basis, of 31.5% glucose, 48.5% galactose, 9.5% fructose, 7.6% gluconic acid and 2.9% oligo/di-saccharides.

### Example 2

Milk permeate was obtained by ultrafiltration of skim milk and had the composition: 4.6% lactose, 0.47% ash, pH 6.5. Permeate (1 kg) was placed in a flask and adjusted to pH 7.2 with magnesium carbonate (0.1 g). The flask was heated to 40° C. in a water bath and gently stirred. Lactase (Maxilact L2000, 1.25 g) was added and incubated at 40° C. for 4 hours. The pH of the permeate was measured at intervals and maintained at 7.4 to 7.2 by additions of 1M HCl (1.25 mL total). After 4 hours an aliquot of the permeate was withdrawn for glucose analysis. The glucose content was 2.0%.

The permeate was then heated to 55° C. and vigorously aerated with a stream of air. Glucose oxidase (Fermizyme GO 4000 L, 0.1 mL) and catalase (Catazyme 25L, 1.0 mL) were added and the pH monitored. When the pH reached 4.5, magnesium carbonate was added to raise the pH to 5.2. The pH was then kept between 4.5 and 5.2 by continuous monitoring of the pH and additions of magnesium carbonate, until 3.41 g of magnesium carbonate had been added. The airflow was stopped and the temperature of the flask raised to 60° C.

The pH of the solution was raised to 7.5 by the addition of magnesium carbonate. Glucose isomerase (Sweetzyme IT, 10 g) was then added and kept in suspension by gentle stirring with an overhead stirrer and incubated for 2 hours. The solution was then cooled and the Sweetzyme allowed to settle. The supernatant solution was decanted from the settled enzyme through a filter paper (Whatman 541).

The solution was analysed for glucose, galactose, fructose, lactose and gluconic acid by HPLC. The composition (%w/w) of the solution was 0.70% glucose, 1.78% galactose, 0.47% fructose, 0.64% oligo/di-saccharides and 1.05% gluconic acid, and 4.6° Brix. This corresponded to a sugar composition, on a dry weight basis, of 15.0% glucose, 38.4% galactose, 10.1% fructose, 22.6% gluconic acid and 13.7% oligo/di-saccharides.

### Example 3

Lactose hydrate (BDH, 50 g) was dissolved in milk permeate (1 kg) obtained by ultrafiltration of whole milk and comprising 4.6% lactose, 0.47% ash. The pH of the solution was raised to 8.0 by the addition of dipotassium hydrogen phosphate (32 g). The solution was heated to 50° C. and held at this temperature for 15 minutes. It was then cooled and centrifuged.

The supernatant was adjusted to pH 7.2, and lactase (Lactozyme 3000L, 2.5 g) was added. The temperature was raised to 45° C. and hydrolysis allowed to proceed for 6 hours. The solution was analysed for glucose. The glucose concentration was 5.13%.

The temperature was then raised to 60° C., magnesium chloride hexahydrate (0.5 g) and glucose isomerase (Sweetzyme IT, 10 g) were added and kept in suspension by gentle stirring with an overhead stirrer, Incubation was continued for 2.5 hours, and then the solution was cooled, and the Sweetzyme allowed to settle. The supernatant solution was decanted from the settled enzyme through a filter paper (Whatman 541).

The isomerised solution was heated to 50° C., and sparged with oxygen. Glucose oxidase (Enzidase GO 1500, 0.25 g) and catalase (Catazyme 25L, 1.0 g), together with 3.5 g calcium carbonate, were then added and the enzyme reactions allowed to proceed for 7 hours. The composition (%w/w) of the product was 0.04% glucose, 4.80% galactose, 1.77% fructose, 0.94% oligo/di-saccharides and 4.86% gluconic acid, and 12.40 Brix. This corresponded to a sugar composition, on a dry weight basis, of 0.3% glucose, 38.7% galactose, 14.3% fructose, 39.2%gluconic acid and 7.7% oligo/di-saccharides.

### Example 4

Wyndale refined edible lactose (200 g) was dissolved in deionised water (800 g) and adjusted to pH 7.2 with 0.1 g tripotassium citrate, 0.03 g dipotassium hydrogen phosphate and 0.12 g of potassium dihydrogen phosphate. The temperature of the solution was raised to 45° C. in a waterbath, and Lactase (Lactozyme 3000L, 3.7 g,) was added. The enzymatic hydrolysis was allowed to continue for 12 hours. The pH was checked from time to time, and dipotassium hydrogen phosphate added to maintain the pH at 7.0 to 7.3. After 12 hours the glucose concentration was checked and found to be 9.7%.

The temperature of the flask was raised to 55° C. and the solution was sparged with oxygen. Glucose oxidase (Enzidase GO 1500, 0.56 g) was added, and the pH allowed to fall to 5.2, and then maintained at this pH by the addition of 10M sodium hydroxide. Alkali was added until 7.0% of the glucose in the solution had been converted to gluconic acid (3.6 mL), and then the oxygen flow was turned off, and the pH was raised to 7.5.

The solution was heated to 60° C., and then it was allowed to percolate through a column of glucose isomerase (Sweetzyme IT) at a flow rate of 2.5 bed volumes per hour. The eluate was then evaporated in a rotary evaporator until the solids content reached 73° Brix.

The composition (% w/w) of the solution was 25.92% glucose, 35.11% galactose, 6.94% fructose, 2.56% gluconic acid and 2.46% oligo/di-saccharides, and 73° Brix. This corresponded to a sugar composition, on a dry weight basis, of 35.5% glucose, 48.1% galactose, 9.5% fructose, 3.5% gluconic acid and 3.4% oligo/di-saccharides.

The solution was allowed to cool to room temperature (20° C.). After two hours crystals started to appear. After standing for three days the crystals, which amounted to about 24% of the original sugars, were filtered off and reserved for admixture with other syrups. The composition (% w/w) of the supernatant syrup was 23.17% glucose, 25.60% galactose, 5.93% fructose, 2.41% gluconic acid and 3.28% oligo/di-saccharides, corresponding to a sugar composition, on a dry weight basis, of 38.37% glucose, 42.39% galactose, 9.82% fructose, 3.99% gluconic acid and 5.43% oligo/di-saccharides. The composition of the crystals was approximately 89% galactose.

### Example 5

Lactose hydrate (BDH, 30 g) was dissolved in 150 g distilled water, heated to 90° C. and then percolated down a column of cation exchange resin (Dowex 50-X8) in the hydrogen form at 90° C. at 0.15 bed volumes per hour. The emergence of the hydrolysed syrup from the column was monitored by refractometry, and the eluate was analysed for its sugar composition. The total sugar concentration was 16.17%, and the glucose concentration was 6.88%.

The hydrolysed syrup was adjusted to pH 7.5 with magnesium carbonate. The syrup was heated to 60° C. and then percolated down a column of immobilized glucose isomerase (Sweetzyme IT) at 60° C. and a rate of 0.3 bed volumes per hour. The isomerised syrup was then immediately passed through a column of activated carbon (Norit GAC 1240) at 60° C.

The syrup (120 mL) was then placed in a pH stat at 60° C. The temperature of the flask was raised to 55° C. and the solution was sparged with oxygen. Glucose oxidase (Enzidase GO 1500, 0.033 mL) and catalase (Catazyme 25L, 0.133 mL) were added. Two further additions of Catazyme (0.033 mL) were made during the run, to maintain a fast rate of oxidation). The pH was kept between 6.8 and 7.2 by the addition of 10M sodium hydroxide. In all, 1.52 mL of alkali were added corresponding to 75% conversion of the glucose to gluconic acid.

The final syrup was analysed for glucose, galactose, fructose, lactose and gluconic acid by HPLC. The composition (% w/w) of the solution was 0.90% glucose, 6.7% galactose, 1.89% fructose, 2.59% oligo/di-saccharides and 2.71% gluconic acid, and 14.8° Brix. This corresponded to a sugar composition, on a dry weight basis, of 6.1% glucose, 45.3% galactose, 12.8% fructose, 18.3% gluconic acid and 17.5% oligo/di-saccharides.

### Example 6

Milk permeate was obtained by the ultrafiltration of milk and had the composition: 3.37% lactose, 0.47% ash, 0.013% calcium. Permeate (1 kg) was stirred with 200 mL wet cation exchange resin (Dowex 50-X8) in the potassium form for 30 minutes. The resin was allowed to settle, and the permeate was decanted off through a filter paper (Whatman 541). The calcium content of the solution after this treatment was undetectable. Some dilution occurred, reducing the lactose concentration to 3.06%. The acid solution was adjusted to pH 5 with potassium hydroxide (0.1M). It was then hydrolysed with Fungal Lactase (I g) at 50° C. for 18 hours. The pH was checked periodically and maintained at 5. After hydrolysis, the lactose concentration was reduced to 0.13% and the glucose concentration was 1.53%. The solution was then divided into 2 halves, A and B.

Half A was raised to 55° C. and vigorously sparged with oxygen. Glucose oxidase (Novozyme 37007, 0.1%) and catalase (Catazyme 25L, 1.0 mL) were added and the pH monitored. When the pH reached 4.5, calcium carbonate was added to raise the pH to 5.2. The pH was then kept between 4.5 and 5.2 by continuous monitoring of the pH and additions of calcium carbonate, until 1.6 g of calcium carbonate had been added. Virtually all the glucose had been oxidised to gluconic acid at this point. The oxygen flow was stopped and the solution cooled and filtered (Whatman No 4) to remove the proteinaceous sediment.

Half B was raised to 60° C. and glucose isomerase (Sweetzyme IT, 5 g) was added and kept in suspension by gentle stirring with an overhead stirrer. Incubation was continued for 2.5 hours, and then the solution was cooled, and the Sweetzyme allowed to settle. The supernatant solution was decanted from the settled enzyme through a filter paper (Whatman No 4).

Both portions, A and B, were analysed for oligo/disaccharides, galactose, glucose, fructose and gluconic acid, and then the solutions were mixed. The composition (w/w) of the product was 0.63% glucose, 1.43% galactose, 0.17% fructose, 0.13% oligo/di-saccharides and 0.74% gluconic acid and 3.1° Brix. This corresponded to a sugar composition, on a dry weight basis, of 20.3% glucose, 46.1% galactose, 5.5% fructose, 23.9% gluconic acid and 4.2% oligo/di-saccharides.

### Example 7

Wyndale brand Refined Edible grade lactose (1000 kg) was dissolved along with 2.5 kg of potassium citrate and 2.5 kg of magnesium chloride in demineralised water and heated to form a 20% TS solution at 75° C. The solution was adjusted to pH 7.2 with dipotassium hydrogen phosphate and cooled to 46 C. Maxilact L2000 enzyme (18.8 kg) was added and the solution incubated for 12 hours.

Oxygen was then sparged into the tank at 10 L/min and 250 g of Enzidase GO 1500 added plus 50 mL of Catazyme 25L. NaOH was added as a 50% solution to maintain pH 6.2. During oxidation the tank was heated at 10° C. per hour then held at 55° C.

The reaction mixture was then evaporated to 40% TS, exiting at 60° C. then pumped at 3.3 LUmin through a column containing 13.3 kg of Sweetzyme IT then a 1 μm security filter. This syrup was heat treated at 80° C. for 13 seconds and evaporated to 72° Brix.

The final syrup was analysed for glucose, galactose, fructose, lactose and gluconic acid by HPLC. The composition of the sugars was 28.2% glucose, 47.4% galactose, 17.6% fructose, 3.6% oligo/di-saccharides and 3.3% gluconic acid.

### Example 8

A sports drink was prepared according to the recipe (per 500 mL serving):

| | | |
|---|---|---|
| Syrup prepared in example 7: | 35 | g |
| Sodium chloride | 0.2 | g |
| Citric acid | 0.2 | g |
| Orange-lemon flavouring | 0.5 | g |
| Ascorbic acid | 0.2 | g |
| Water | 464 | g |

The drink was made up, then heat treated at 80° C. for 30 seconds and hot-filled at 80° C. into 330 mL PET bottles.

This drink contained:

| | |
|---|---|
| Galactose | 2.4% |
| Glucose | 1.4% |
| Fructose | 0.9% |
| Di and oligosaccharides | 0.2% |
| Gluconic acid | 5 mmol/L |
| Citric acid | 2 mmol/L |
| Ascorbic acid | 2 mmol/L |
| Sodium | 13 mmol/L |
| Potassium | 4 mmol/L |
| Magnesium | 1 mmol/L |
| Chloride | 7 mmol/L |
| Phosphorous | 1 mmol/L |

The drink was measured at pH 3.9 and osmolality 170 mosm/kg. It was very slightly opalescent and was stable on standing at room temperature. It had a clean fresh flavour with very good balance of sweetness and clean acid with no discernable salty background. Test subjects consumed a 330 mL serving easily before exercise and reported that it was highly palatable, gave no gastric discomfort even with subsequent intense exercise and resulted in reduced signs of fatigue in comparison to water and glucose based alternatives.

### Example 9

A sports energy bar was prepared according to the recipe (per 100 g serving):

| | | |
|---|---|---|
| Syrup prepared in example 7: | 20.0 | g |
| Rennet casein | 17.0 | g |
| Milk protein concentrate | 6.2 | g |
| Whey protein isolate | 2.2 | g |
| Milk fat | 8.9 | g |
| Locust bean gum | 0.13 | g |
| Disodium phosphate dihydrate | 1.60 | g |
| Citric acid | 0.68 | g |
| Apricot pieces | 11.5 | g |
| Apricot flavour | 0.40 | g |
| Water | 31.4 | g |

The bar was calculated to deliver per 100 g:

| | | |
|---|---|---|
| Protein | 21.6 | g |
| Fat | 8.9 | g |
| Carbohydrate | 20.2 | g |
| Energy | 1039 | kJ |

The bar had a soft chewy texture and a sweet fruity flavour. A panel of consumers rated it as highly palatable and satisfying to eat.

It will be appreciated that it is not intended to limit the invention to the above examples only, many variations being possible, as would readily be understood by a skilled worker, without departing from the scope of the appended claims.

1. A process comprising the steps:
(i) hydrolysis of lactose to produce glucose and galactose;
(ii) partial isomerisation of the glucose to fructose; and
(iii) partial oxidation of the glucose to gluconic acid;
to produce a composition comprising a mixture of galactose, glucose, fructose, gluconic acid, unconverted lactose and non-lactose di- and oligo-saccharides.

2. A process as claimed in claim 1 for the production of a composition comprising a mixture of approximately 10-50% galactose, 0-48% glucose, 1-25% fructose, 1-48% gluconic acid and 0-25% unconverted lactose and non-lactose di- and oligo-saccharides as a % of the total carbohydrate present.

3. A process as claimed in claim 2, wherein the composition comprises 30-50% galactose, 10-40% glucose, 5-25% fructose, 1-15% gluconic acid and 1-10% unconverted lactose and non-lactose di- and oligo-saccharides.

4. A process as claimed in claim 3, wherein the composition comprises 45-50% galactose, 23-33% glucose, 15-23% fructose, 1-5% gluconic acid and less than 7% unconverted lactose and non-lactose di- and oligo-saccharides.

5. A process as claimed in claim 1 carried out as a continuous, semicontinuous, batch, sequence batch or single-pot process.

6. A process as claimed in claim 1, wherein the isomerisation step (ii) is carried out after the oxidation step (iii).

7. A process as claimed in claim 1, wherein the hydrolysis step (i) and oxidation step (iii) are carried out simultaneously.

8. A process as claimed in claim 1, wherein the product of step (i) is separated into three streams wherein the first stream is not treated further and the second and third streams are treated according to steps (ii) and (iii) respectively and the products of each stream combined to provide a final composition comprising a mixture of approximately 10-50% galactose, 0-48% glucose, 1-25% fructose, 1-48% gluconic acid and 0-25% unconverted lactose and non-lactose di- and oligo-saccharides as a % of the total carbohydrate present.

9. A process as claimed in claim 8, wherein the product of the partial isomerisation step (ii) is split and a portion subjected to partial oxidation (step (iii)) and the remainder combined with the product of the partial oxidation step to produce a composition comprising a mixture of approximately 10-50% galactose, 0-48% glucose 1-25% fructose, 1-48% gluconic acid and 0-25% unconverted lactose and non-lactose di- and oligo-saccharides as a % of the total carbohydrate present.

10. A process as claimed in claim 8, wherein the product of the partial oxidation step (iii) is split and a portion subjected to partial isomerisation (step (ii)) and the remainder, combined with the product of the partial isomerisation step to produce a composition comprising a mixture of approximately 10-50% galactose, 0-48% glucose, 1-25% fructose, 1-48% gluconic acid and 0-25% unconverted lactose and non-lactose di- and oligo-saccharides as a % of the total carbohydrate present.

11. A process as claimed in claim 1, wherein the lactose source is selected from the group comprising milk; UF permeate derived from whole milk, skim milk, whey or milk serum; pure lactose; whey; deproteinated whey; demineralised whey; decalcified whey; UF permeate derived from deproteinised, demineralised or decalcified whey; or any combination thereof.

12. A process as claimed in claim 1, wherein the hydrolysis step (i) is achieved chemically, or enzymatically using one or more hydrolytic enzymes, or in a bioreactor.

13. A process as claimed in claim 12 wherein the hydrolysis step (i) is achieved chemically by the use of acids or strong cation exchange resins.

14. A process as claimed in claim 13, wherein the acids comprise a weak solution (0.001-0.1% of total weight of lactose) of one or more acids selected from hydrochloric acid, suphuric acid, phosphoric acid, nitric acid and citric acid.

15. A process as claimed in claim 12, wherein the hydrolytic enzyme is a beta-galactosidase, also known as lactase, and is free or immobilized and is sourced from Kluyveromyces lactis, Kluyveromyces fragilis, Kluyveromyces marxianus, Saccharomyces fragilis, Streptococcus thermophilus, Aspergillus oryzae, Aspergillus niger, Lactobacillus bulgaricus, Lactobacillus helviticus, Lactobacillus salivarius, Lactobacillus fermentum, Lactobacillus casei, Lactobacillus acidophilus, Streptococcus lactis, Bifidobacterium bifidum, Bifidobacterium longum, Bifidobacterium adolescentis, Bifidobacterium breve, Bacillus subtilis, Escherichia coli, Sulfolobus species, Pyrococcus fusiosus, green coffee beans, jack beans, bovine liver, and bovine testes and any other suitable source either alone or in combination.

16. A process as claimed in claim 15 wherein the enzyme is sourced from Sulfolobus solfataricus.

17. A process as claimed in claim 1, wherein the isomerisation step (ii) is achieved enzymatically, using glucose isomerase.

18. A process as claimed in claim 17, wherein said glucose isomerase is free or immobilized and is sourced from Actinoplanes missiourensis, Bacillus coagulans, Streptomyces murinus, Escherichia coli or Arthrobacter species, or any other suitable source either alone or in combination.

19. A process as claimed in claim 1, wherein the oxidation step (iii) is achieved enzymatically using a glucose oxidase and a catalase.

20. A process as claimed in claim 19, wherein said enzymes are free or immobilized, and wherein the oxidase enzyme is sourced from Penicillium notatum, Penicilliuim glaucanum, Penicillium amagosakiense and Aspergillus niger, and the catalase enzyme is sourced from Aspergillus niger, one or more Pencillium species and Micrococcus lysodeikitcus, or wherein said enzymes are obtained from any other suitable source either alone or in combination.

21. A composition produced by the process of claim 1, wherein said composition comprises a mixture of galactose, glucose, fructose, gluconic acid and unconverted lactose and non-lactose di-oligo-saccharides.

22. A composition as claimed in claim 21, wherein, in an undiluted form, the composition is in the form of syrup of 40 to 80° Brix.

23. A composition as claimed in claim 22 further comprising a diluent.

24. A composition comprising approximately 10-50% galactose, 0-48% glucose, 1-25% fructose, 1-48% gluconic acid and 0-25% unconverted lactose and non-lactose di- and oligo-saccharides as a % of the total carbohydrate present.

25. A composition as claimed in claim 24 comprising 30-50% galactose, 10-40% glucose, 5-25% fructose, 1-15% gluconic acid and 1-10% unconverted lactose and non-lactose di- and oligo-saccharides.

26. A composition as claimed in claim 25, comprising 45-50% galactose, 23-33% glucose, 15-23% fructose, 1-5% gluconic acid and less than 7% unconverted lactose and non-lactose di- and oligo-saccharides.

27. A food comprising a composition as claimed in claim 24.

28. A food as claimed in claim 27, comprising a sports energy bar.

29. A drink comprising a composition as claimed in claim 24.

30. A drink as claimed in claim 29, comprising a sports drink, wherein said sports drink contains less than 25 mmol/litre of sodium.

31. A process for the production of galactose comprising the steps:
(i) hydrolysis of lactose to produce glucose and galactose;
(ii) partial isomerisation of the glucose to fructose;
(iii) partial oxidation of the glucose to gluconic acid;
(iv) crystallization of galactose to produce a mother liquor; and
(v) recovery of galactose crystals from the mother liquor.

32. Galactose produced by the process of claim 31.

33. A composition comprising the mother liquor produced by the process of claim 31.

34. A use of the composition of claim 33 as a sweetener in the food industry.

35. A use as claimed in claim 34, wherein the food industry is the dairy food industry.
